(19) United States
(12) Patent Application Publication
(10) Pub. No.: US 2024/0339689 A1
(43) Pub. Date: Oct. 10, 2024

(54) RECYCLING METHOD OF POSITIVE ELECTRODE MATERIAL FOR SECONDARY BATTERIES AND DEVICE USING THE SAME

(71) Applicant: KOREA ATOMIC ENERGY RESEARCH INSTITUTE, Daejeon (KR)

(72) Inventors: Min Ku JEON, Sejong-si (KR); Sung Wook KIM, Daejeon (KR); Keun Young LEE, Sejong-si (KR); Hee Chul EUN, Sejong-si (KR); Maeng Kyo OH, Daejeon (KR)

(21) Appl. No.: 18/682,621

(22) PCT Filed: Nov. 4, 2021
(86) PCT No.: PCT/KR2021/015932

§ 371 Date: Feb. 9, 2024

(30) Foreign Application Priority Data
Aug. 9, 2021 (KR) 10-2021-0104289

(51) Int. Cl. H01M 10/54; B09B 3/70; B09B 3/80; B09B 101/16; C01D 15/08

(52) U.S. Cl. CPC H01M 10/54; B09B 3/70; B09B 3/80; C01D 15/08; B09B 2101/16; C01P 2002/72; C01P 2006/40

(57) ABSTRACT

The present invention provides a method for recycling a positive electrode material for secondary batteries that can not only safely separate positive electrode materials included in waste batteries without by-products such as acid waste and the like, but also recycle the rapidly increasing amount of waste batteries through a simple and efficient process, thereby significantly reducing social and economic costs.

### CROSS REFERENCE TO RELATED APPLICATION

This application is a National Stage of International Application No. PCT/KR2021/015932, filed on Nov. 4, 2021, which is based upon and claims priority to Korean Patent Application No. 10-2021-0104289, filed on Aug. 9, 2021, in the Korea Intellectual Property Office. All of the aforementioned applications are hereby incorporated by reference in their entireties.

### TECHNICAL FIELD

The present invention relates to a method for recycling a positive electrode material for secondary batteries, and more specifically to a method for recycling a positive electrode material for secondary batteries that can not only safely separate positive electrode materials included in waste batteries without by-products such as acid waste and the like, but also recycle waste batteries through a simple and efficient process, thereby significantly reducing social and economic costs, and a device for recycling a positive electrode material for secondary batteries using the same.

### BACKGROUND ART

Recently, with the development of the lithium-ion secondary battery industry, the production of batteries using the same is increasing exponentially, and this eventually leads to an increase in the amount of waste batteries that have reached the end of their lifespan, which is expected to cause various problems of social and economic costs due to the disposal problem of waste batteries.

Meanwhile, waste batteries cannot be disposed of like general waste due to fire hazard, toxicity and metal problems, and a separate storage and disposal method must be used. In order to safely dispose of such waste batteries, each component must be disassembled and stabilized before disposal, and the largest cost among the components of such waste batteries is a positive electrode material such as LiCoO₂, Li(Ni, Co, Al) O₂, LiMnO₂, Li(Ni, Co, Mn)O₂ and the like

Accordingly, in order to solve the problems of social and economic costs of disposing of waste batteries and to recycle the above-described positive electrode materials, research on methods of dissolving the entire positive electrode material in a strong acid solution, and then gradually precipitating the desired metal and separating through the input of additives is in progress, but due to the following problems, the use thereof in actual industries is limited.

First, nickel, cobalt, aluminum, manganese and the like, which are metal materials used as positive electrode materials for secondary batteries, have similar chemical properties, and thus, it is difficult to separate them only as pure substances, and an additional purification process is essentially required to separate into only pure substances. This caused the complexity of the recycling process step and the problem of additional costs, which resulted in very poor recycling efficiency and economic feasibility.

Second, the above method has a problem in that an additional purification process is required not only for the positive electrode material, but also for Li dissolved in acid. That is, since Li has better dissolution properties than other metals used in the positive electrode material, Li may be separated together during the separation process of other metals, thereby increasing the burden on the above-described purification process.

Third, due to such properties of Li, there is a difficulty in the process of re-mixing a Li precursor and synthesizing and recycling in the same composition as the original material. This is because, due to Li included in the separation process of other metals, an additional purification process is required to re-purify the same during the resynthesis process.

Accordingly, the situation is that there is an urgent need for research on a simple and efficient recycling method of a positive electrode material for secondary batteries, in which the components of waste batteries can be safely disassembled and disposed of, thereby reducing social and economic costs through recycling, and the above-mentioned problem of separation efficiency is solved such that an additional process is not required and it is possible to selectively recover the positive electrode material.

### DISCLOSURE OF INVENTION

### Technical Problem

The present invention has been devised to overcome the aforementioned problems, and the first problem to be solved by the present invention is directed to providing a method for recycling a positive electrode material for secondary batteries, which can safely separate and recycle the positive electrode materials included in waste batteries to reduce social and economic costs due to the rapidly increasing use of secondary batteries, and a recycling device using the same.

### Solution to Problem

In order to solve the aforementioned problems, the present invention provides a method for recycling a positive electrode material for secondary batteries, including (1) forming a first mixture by chlorinating a positive electrode material including LMOₓ separated from a battery with a gas including chlorine S100, (2) contacting the first mixture with a solvent to separate MOₓ and forming a second mixture including the solvent S200, (3) separating MCO₃ by reacting the second mixture with carbonate S300, and (4) separating lithium carbonate (Li₂CO₃) from the second mixture from which MCO₃ is separated S400. In this case, L is lithium (Li), M is one or more selected from cobalt (Co), nickel (Ni), aluminum (Al) and manganese (Mn), and X is a constant of 0.5 to 2.5.

In addition, according to an exemplary embodiment of the present invention, the temperature for chlorinating may be 450 to 700° C.

In addition, according to another exemplary embodiment of the present invention, the gas including chlorine may be chlorine gas (Cl₂).

In addition, according to still another exemplary embodiment of the present invention, the first mixture in step (1) may include LiCl, MCl_{y} and MOₓ, and in this case, y is a constant of 1 to 3.

In addition, according to an exemplary embodiment of the present invention, the chlorine gas may be included at 5 to 90 wt. % based on the total weight of the gas including chlorine.

In addition, according to another exemplary embodiment of the present invention, the solvent in step (2) may be any one or more of water or alcohol.

In addition, according to still another exemplary embodiment of the present invention, the carbonate in step (3) may be any one of sodium carbonate or potassium carbonate.

In addition, according to an exemplary embodiment of the present invention, step (4) may be drying the second mixture from which MCO₃ is separated to remove a part of the solvent to separate lithium carbonate by a difference in solubility with respect to the solvent.

In addition, according to an exemplary embodiment of the present invention, step (4) may further include (4-1) drying the second mixture from which MCO₃ is separated to remove all or part of the solvent (S410); and (4-2) additionally introducing a second solvent to separate lithium carbonate and sodium chloride included in the second mixture by using a difference in solubility with respect to the solvent (S420).

In addition, according to an exemplary embodiment of the present invention, the aforementioned step may further include reproducing LMOₓ by using the separated MOₓ, MCO₃ and lithium carbonate (S430).

In addition, the present invention provides a positive electrode material for secondary batteries, which is reproduced by the aforementioned method for recycling a positive electrode material for secondary batteries.

In addition, the present invention provides a method for recycling a positive electrode material for secondary batteries, including separating MOₓ by chlorinating a positive electrode material including LMOₓ separated from a battery with a gas including chlorine. In this case, L is lithium (Li), M is one or more selected from cobalt (Co), nickel (Ni), aluminum (Al) and manganese (Mn), and X is a constant of 0.5 to 2.5.

In addition, the present invention provides a device for recycling a positive electrode material for secondary batteries, including a first reaction unit for forming a first mixture by chlorinating a positive electrode material including LMOₓ separated from a battery with a gas including chlorine, a first separation unit for communicating with the first reaction unit and contacting the first mixture with a solvent to separate MOₓ and forming a second mixture including the solvent, a second separation unit for communicating with the first separation unit and separating MCO₃ by reacting the second mixture with carbonate, and a third separation unit for communicating with the second separation unit and separating lithium carbonate from the second mixture from which the MCO₃ is separated. In this case, L is lithium (Li), O is oxygen, M is one or more selected from cobalt (Co), nickel (Ni), aluminum (Al) and manganese (Mn), and X is a constant of 0.5 to 2.5.

In addition, according to an exemplary embodiment of the present invention, the device may further include a synthesis unit for communicating with the first separation unit, the second separation unit and the third separation unit and reproducing LMOₓ from MOₓ, MCO₃ and lithium carbonate separated in the first separation unit, the second separation unit and the third separation unit.

In addition, according to another exemplary embodiment of the present invention, the first reaction unit may further include a gas injection unit for injecting gas into the first reaction unit.

In addition, according to still another exemplary embodiment of the present invention, the first reaction unit may further include a heater for maintaining a gas including chlorine at a high temperature.

In addition, according to an exemplary embodiment of the present invention, the first separation unit may further include a solvent injection unit for injecting a solvent.

### Advantageous Effects

According to the method for recycling a positive electrode material for secondary batteries according to the present invention, it is possible to safely separate and efficiently recycle positive electrode materials included in waste batteries, thereby reducing social and economic costs due to the rapidly increasing use of secondary batteries.

In addition, according to the method for recycling a positive electrode material for secondary batteries according to the present invention, it is possible to omit a purification process which was additionally required due to the chemical properties of the positive electrode material in the process of separating the positive electrode materials included in waste batteries, thereby simplifying the overall process, and moreover, it is possible to maximize the efficiency of the separation process.

Furthermore, according to the method for recycling a positive electrode material for secondary batteries according to the present invention, no additional acid waste is generated because strong acid is not used in the process of separating the positive electrode materials included in waste batteries, and only Li can be selectively recovered such that it is possible to significantly improve the treatment efficiency and economic feasibility in the separation process, as well as the resynthesis process.

### DESCRIPTION OF DRAWINGS

FIG. 1 is a flowchart schematically illustrating the method for recycling a positive electrode material for secondary batteries according to an exemplary embodiment of the present invention.

FIG. 2 is a flowchart schematically illustrating the method for recycling a positive electrode material for secondary batteries according to another exemplary embodiment of the present invention.

FIGS. 3A to 31 are graphs showing the results of X-ray diffraction analysis of positive electrode materials of waste batteries that were subjected to a chlorination reaction according to an exemplary embodiment of the present invention.

FIG. 4 is a photograph showing the separation of brown MCO₃ as a precipitate after the chlorination reaction was performed according to an exemplary embodiment of the present invention.

FIG. 5 is a photograph showing that all of the solvent was evaporated by drying the solution from which MOₓ and MCO₃ were removed in a vacuum condition at 120° C. according to an exemplary embodiment of the present invention.

FIG. 6 is a graph showing the results of X-ray diffraction analysis of FIG. 5 according to an exemplary embodiment of the present invention.

FIG. 7 is a photograph showing the separation of Li₂CO₃ as a precipitate from a Li₂CO₃/NaCl/H₂O solution according to an exemplary embodiment of the present invention.

FIG. 8 is a graph showing the analysis results of the X-ray diffraction experiment of FIG. 7 according to an exemplary embodiment of the present invention.

FIG. 9 is a graph showing the results of X-ray diffraction analysis of Li₂CO₃ separated using methanol from a Li₂CO₃/NaCl mixture according to an exemplary embodiment of the present invention.

FIG. 10 is a flowchart illustrating the resynthesis step of a positive electrode material according to an exemplary embodiment of the present invention.

FIG. 11 is a graph showing the results of X-ray diffraction experiments of a resynthesized sample according to an exemplary embodiment of the present invention.

FIG. 12 is a graph showing the results of charge/discharge experiments of a resynthesized sample according to an exemplary embodiment of the present invention.

FIG. 13 is a diagram showing the device for recycling a positive electrode material for secondary batteries according to the present invention.

### BEST MODE FOR CARRYING OUT THE INVENTION

Hereinafter, exemplary embodiments of the present invention will be described in detail such that those of ordinary skill in the art to which the present invention pertains can easily practice the same. The present invention may be embodied in many different forms and is not limited to the exemplary embodiments described herein.

As described above, the conventional process of recycling waste batteries has problems in that a lot of costs are required socially and economically, because the separation efficiency is low, an additional process is required, and by-products are generated through strong acid treatment, and thus, there was a limitation to the utilization in actual industries.

Accordingly, the present invention sought a solution to the aforementioned problems by providing a method for recycling a positive electrode material for secondary batteries, including forming a first mixture by chlorinating a positive electrode material including LMOₓ separated from a battery with a gas including chlorine S100, contacting the first mixture with a solvent to separate MOₓ and forming a second mixture including the solvent S200, separating MCO₃ by reacting the second mixture with carbonate S300, and separating lithium carbonate (Li₂CO₃) from the second mixture from which MCO₃ is separated S400.

Through this, accordingly, it is possible to safely disassemble and dispose of the components of waste batteries and reduce social and economic costs through recycling, and moreover, by solving the aforementioned problem of separation efficiency, simple and efficient recycling of the positive electrode material for secondary batteries may be possible, in which an additional process is not required and it is possible to selectively recover the positive electrode material.

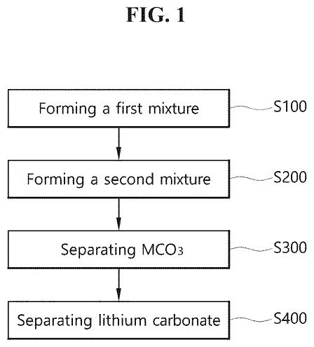

FIG. 1 is a flowchart schematically illustrating the method for recycling a positive electrode material for secondary batteries according to an exemplary embodiment of the present invention, which will be referenced below to describe the present invention in more detail.

In the present invention, as step (1), a first mixture is formed by chlorinating a positive electrode material including LMOₓ separated from a battery with a gas including chlorine S100.

In this case, L is lithium (Li), M is one or more selected from cobalt (Co), nickel (Ni), aluminum (Al) and manganese (Mn), and X is a constant of 0.5 to 2.5.

As a conventional recycling method of a positive electrode material for secondary batteries, there is a method of separating lithium and positive electrode metal materials by leaching a waste battery in a strong acid solution as described above. However, in addition to the problem of the additional generation of acid wastes, the separation method using strong acid in this way has a problem in that, due to the reactivity of lithium, it is separated together in the separation process of other metals such that that an additional purification process for separating lithium is required, or separation efficiency is significantly reduced due to similar chemical properties of the metals.

As such, the present invention solves the aforementioned problem by chlorinating the positive electrode material with a gas including chlorine. More specifically, in waste batteries, an oxide in the form of LiMO₂, which is a positive electrode material, may be formed, and in the method for recycling the positive electrode material according to the present invention, the oxide in the form of LiMO₂, which is a positive electrode material, is subjected to a chlorination reaction performed in step (1) to separate into lithium and a positive electrode material of MOₓ, respectively. That is, lithium may be converted into LiCl, and M, which is a positive electrode metal material, may be separated into an oxide in the form of MOₓ or MCl_{y}. However, most of M is separated into an oxide in the form of MOₓ, and may be recycled as a positive electrode material for secondary batteries through a separation process to be described below. Through this, the present invention may simplify the entire process through the selective and simple recovery of chlorides including lithium without generating secondary acid wastes, thereby maximizing treatment efficiency and process efficiency.

In this case, the chlorination reaction in step (1) may be carried out at 450 to 700° C., more preferably, at a temperature of 520 to 620° C., and the temperature of the chlorination reaction may be the temperature of the gas. In this case, if the temperature of the chlorination reaction is less than 450° C., lithium chloride is not sufficiently formed, and thus, there may be a problem in that the separation efficiency of the waste battery is lowered. In addition, if the temperature of the chlorination reaction is more than 700° C., there may be a problem in that the generated LiCl is volatilized and lost due to excessively high temperature. In addition, the chlorination reaction according to the present invention may be reacted under the above-described temperature condition for 1 to 8 hours, and more preferably, for 2 to 6 hours.

Meanwhile, the amount of the gas including chlorine may be appropriately selected according to the amount of LiMO₂, which is the positive electrode material input from waste batteries, and preferably, it may be mixed at 150 to 1,000 parts by weight based on the total weight of LiMO₂. If the gas including chlorine is included at less than 150 parts by weight based on the total weight of LiMO₂, there may be a problem in that the desired chlorination reaction does not proceed sufficiently such that the yields of LiCl and MOₓ are lowered, and if the gas including chlorine is included at more than 1,000 parts by weight based on the total weight of LiMO₂, there may be a problem in that the process cost increases due to the use of excessive chlorine.

In this case, the gas including chlorine may be Cl₂, HCl, COCl₂ or CCl₄, and preferably, Cl₂. More specifically, the gas including chlorine may be used by mixing the remaining amount of gas such as Ar, N₂, O₂ or the like with the chlorine gas at 5 to 90 wt. % based on the total weight. In this case, if the chlorine gas is mixed at less than 5%, the efficiency of the chlorination reaction may be lowered such that the separation of positive electrode materials including lithium may not be sufficiently performed. In addition, if the chlorine gas is mixed at more than 90%, there may be a problem in that process efficiency is lowered due to the generation of an excess amount of unreacted chlorine gas. Accordingly, the mixing ratio of chlorine gas may be appropriately selected in consideration of the type and content of the positive electrode material in the waste battery.

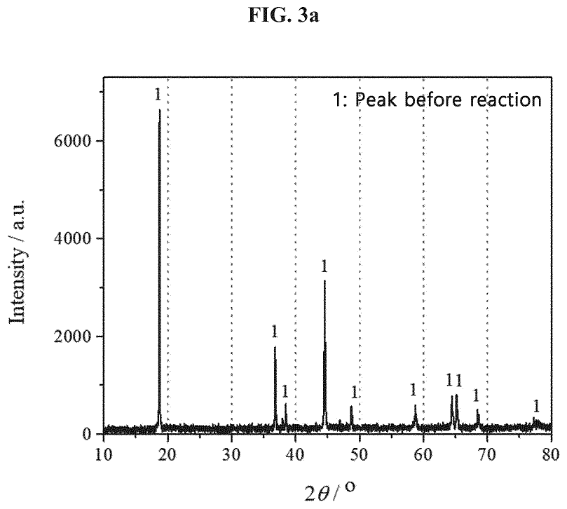

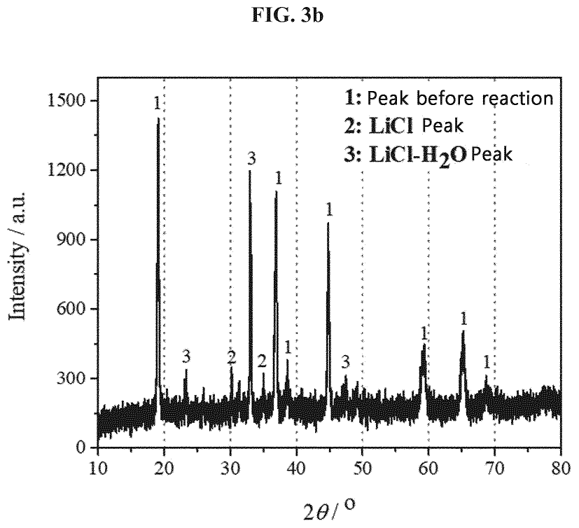

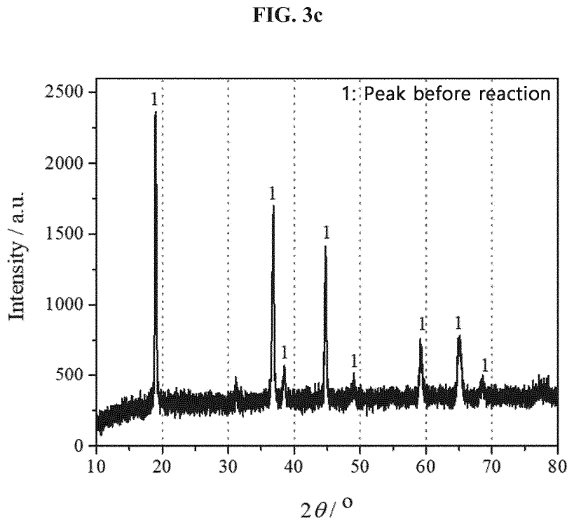

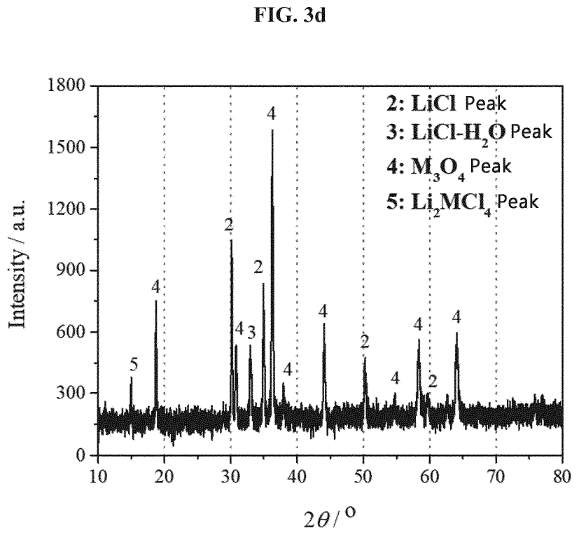

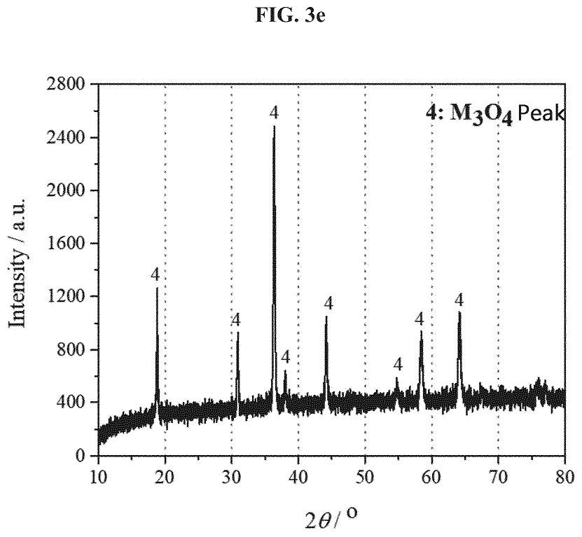

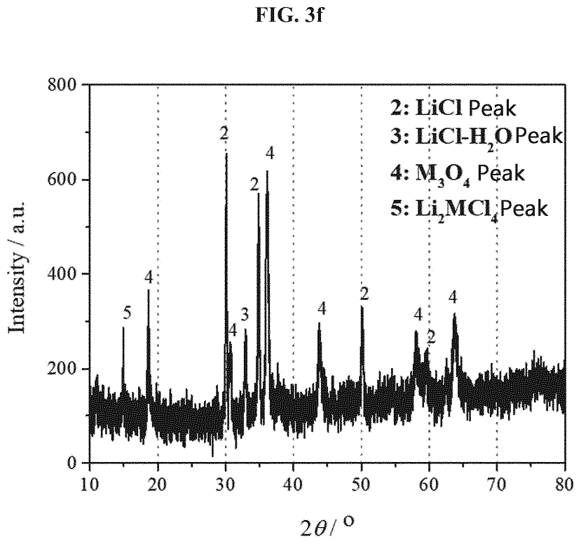

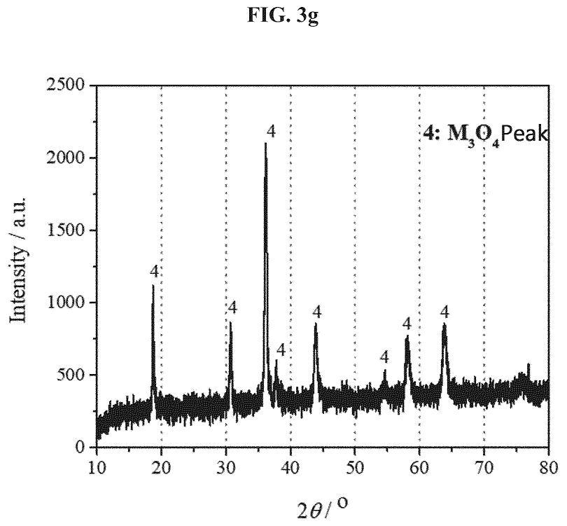

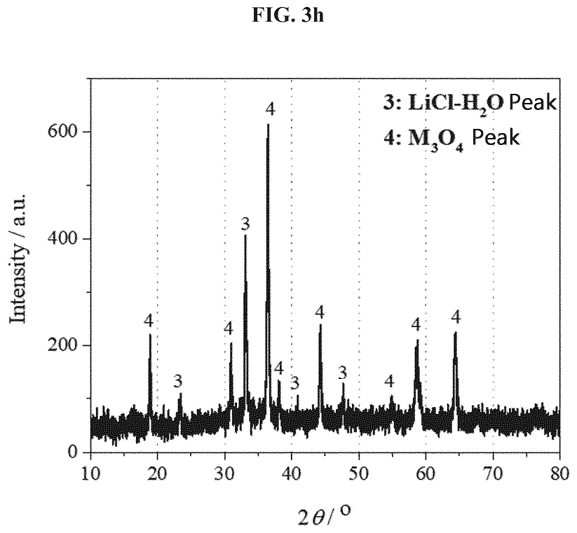

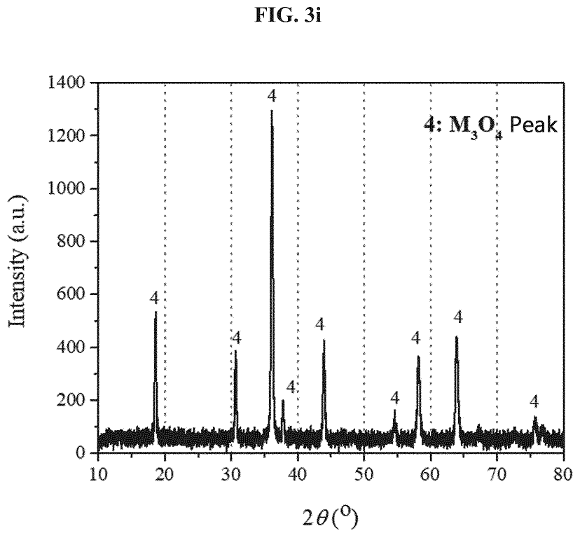

Meanwhile, FIGS. 3A to 31 show the experimental results at the temperature and time for separating lithium into LiCl in step (1) by the method for recycling a positive electrode material for secondary batteries according to the present invention, and these are the results of conducting experiments in the chronological order of 500° C. for 6 hours, 550° C. for 4 hours and 600° C. for 2 hours, respectively.

As illustrated in FIGS. 3A to 31, the production of chloride including LiCl which shows the second peak after step (1) according to the present invention may be confirmed, and the production of M₃O₄ which shows the fourth peak after washing may be confirmed. As a result, it can be seen that the selective separation of lithium is possible through the chlorination reaction according to the present invention, compared to the conventional method of separating the positive electrode material and lithium using an acid, and furthermore, it can be seen that the selective separation efficiency of lithium was the best under the specific temperature and time conditions of the above-described chlorination reaction. In this regard, it will be described below in detail in the Experimental Example.

As described above, since the method for recycling a positive electrode material for secondary batteries according to the present invention can replace the conventional method of treating strong acid by using chlorine gas (Cl₂) in step (1), it is possible to implement an environmentally friendly separation process by suppressing the generation of by-products such as acid wastes or the like, and since an additional purification process or the like is not required, it is possible to simultaneously achieve process simplification and cost reduction.

Next, step (2) of the present invention is a step of contacting the first mixture with a solvent to separate MOₓ and forming a second mixture including the solvent S200.

In the conventional separation method using a strong acid, there is a problem in that the separation efficiency is lowered due to the similar chemical properties of the metal materials of the positive electrode material. That is, not only a specific positive electrode metal material is separated, but also positive electrode metal materials having similar properties are separated together, and an additional metal separation and purification process is required, thereby reducing separation and recycling efficiency.

As such, the present invention solves the aforementioned problem by separating MOₓ through a simple process of step (2) of contacting MOₓ, which is not subjected to a chlorination reaction, with a solvent in the first mixture that has undergone step (1). More specifically, the chloride, such as LiCl or the like, generated in step (1) through the above-described chlorination reaction is dissolved in a solvent and converted to a liquid phase through this step, and MOₓ that does not react with chlorine remains in a solid state and is washed through the solvent, and it may be easily separated as a result. That is, the present invention does not require an additional purification process because the positive electrode metal material may be selectively separated through a simple process of washing and separating through a solvent using the insoluble MOₓ after the chlorination reaction.

In this case, as the solvent used in step (2), a known material capable of dissolving chloride such as LiCl or the like without dissolving MOₓ may be used, and more preferably, either water or alcohol may be used in consideration of the nature and amount of the solvent used in the separation process in steps (3) and (4) to be described below. Most preferably, water may be used, and in this case, it may be more advantageous than alcohol in that it may be operated in a relatively small amount due to the high solubility with respect to LiCl.

Meanwhile, the amount of the solvent introduced in step (2) may be appropriately selected in consideration of the amount of the first mixture transferred in step (1), preferably, it may be mixed at 3,000 to 10,000 parts by weight based on the total weight of the first mixture transferred in step (1).

As such, the method for recycling a positive electrode material for secondary batteries according to the present invention may easily separate MOₓ through step (2) and at the same time implement an environmentally friendly separation process, and since an additional purification process or the like is not required, it is possible to simultaneously achieve process simplification and cost reduction.

Next, step (3) of the present invention is a step of separating MCO₃ by reacting the second mixture formed in aforementioned step (2) with carbonate S300.

As described above, the method for recycling a positive electrode material for secondary batteries according to the present invention has an advantage of separating the positive electrode metal material without treating strong acid, and after the step of separating MOₓ through the chlorination reaction, that is, after contacting the first mixture with a solvent to separate MOₓ and forming a second mixture including the solvent, lithium and MCO₃ included in the second mixture may be easily separated through step (3) of separating MCO₃ by reacting the second mixture with carbonate.

More specifically, in step (3), the second mixture may be reacted with carbonate to produce lithium carbonate (Li₂CO₃) including lithium, MCO₃ including the positive electrode metal material, and NaCl as products. In this case, whereas MCO₃ which is not dissolved in the solvent is precipitated, lithium carbonate and NaCl dissolved in the solvent exist in an aqueous solution state, and thus, MCO₃ may be obtained in a precipitated solid state by separating the same. The separated MCO₃ may be transferred to a synthesis process and recycled as a transition metal precursor.

As the carbonate reacting with the second mixture, a conventional carbonate capable of reacting with lithium and M, which is a positive electrode metal material, to form a salt may be used, and preferably, it may be any one of sodium carbonate or potassium carbonate, and most preferably, it may be sodium carbonate. In this case, it may be more advantageous in terms of process cost than using relatively expensive potassium carbonate.

The amount of such carbonate may be appropriately selected in consideration of the amount of the second mixture formed in step (2), and preferably, it may be mixed at 40 to 400 parts by weight based on the total weight of the second mixture formed in step (2). When carbonate is included at less than 40 parts by weight based on the total weight of the second mixture, sufficient amounts of lithium carbonate and MCO₃ may not be formed, and thus, there is a problem in that separation efficiency is lowered, and when carbonate is included at more than 400 parts by weight, the amount of carbonate is excessive and subsequently, washing and an additional purification process may be required.

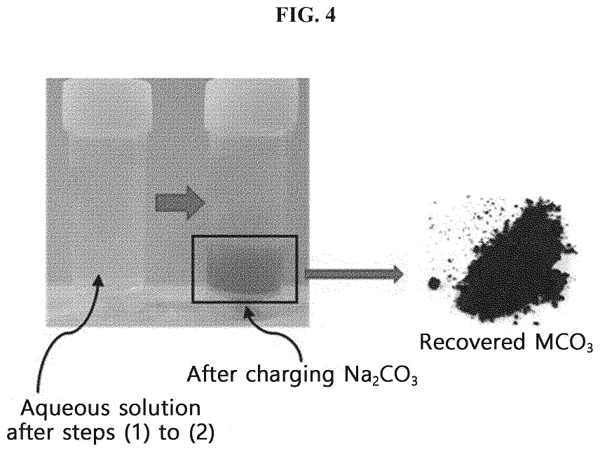

Meanwhile, FIG. 4 shows the experimental results of step (3) in which sodium carbonate was charged into a second mixture including a solvent and separated into a brown MCO₃ precipitate in a solution state. Referring to FIG. 4, MCO₃ having low solubility is precipitated, and lithium carbonate and NaCl having relatively high solubility may exist in a solution state dissolved in a solvent.

As described above, in the method for recycling a positive electrode material for secondary batteries according to the present invention, it is possible to selectively obtain lithium and the positive electrode metal material M by easily separating MCO₃ and Li₂CO₃ through step (3), and at the same time implement an environmentally friendly separation process, and since an additional purification process or the like is not required, it is possible to simultaneously achieve process simplification and cost reduction.

Next, step (4) of the present invention is a step of separating lithium carbonate (Li₂CO₃) from the second mixture from which MCO₃ is separated S400 in aforementioned step (3).

That is, step (4) is a step of selectively recovering lithium by separating Li₂CO₃ and NaCl dissolved in the solvent in aforementioned step (3). In particular, the second mixture may be dried to partially remove the solvent included therein, and lithium carbonate and NaCl present in a solution state in the second mixture may be separated by a difference in solubility with respect to the solvent.

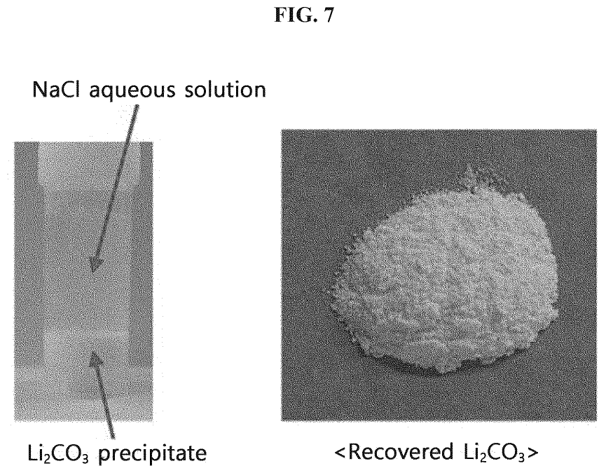

It will be described in more detail with reference to FIG. 7.

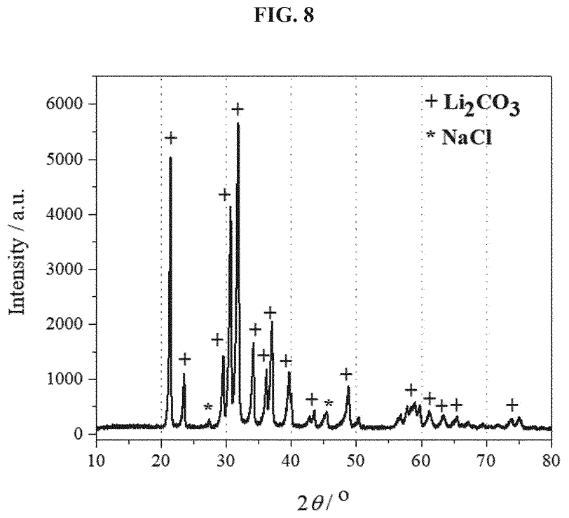

FIG. 7 shows a state in which lithium carbonate and NaCl are separated from the second mixture. That is, referring to FIG. 7, it can be seen that NaCl having a relatively high solubility in the solvent is dissolved in water and exists in an aqueous NaCl solution state, and lithium carbonate having a relatively low solubility in the solvent is separated in a solid form. Furthermore, it can be seen that the recovered Li₂CO₃ precipitate was separated into a high-purity material including only a trace amount of NaCl through the results of the X-ray diffraction experiment of FIG. 8.

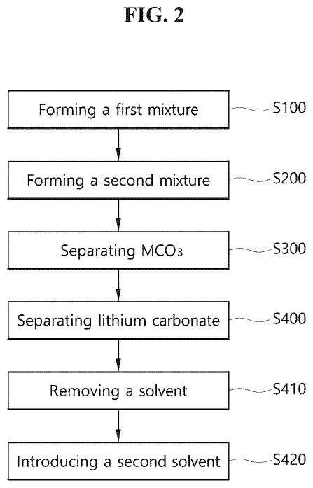

Meanwhile, as illustrated in FIG. 2, in an exemplary embodiment of the method for recycling a positive electrode material for secondary batteries according to the present invention, as step (4-1), step (4) may further include a step of drying the second mixture from which MCO₃ is separated to remove all or part of the solvent S410.

In addition, in another exemplary embodiment of the method for recycling a positive electrode material for secondary batteries according to the present invention, as step (4-2), step (4) may perform a step of completely drying the solvent included the second mixture formed in step (4) above, and additionally introducing a second solvent to separate lithium carbonate and NaCl by using a difference in solubility with respect to the second solvent S420.

In this case, as the second solvent for separating lithium carbonate and NaCl, a conventional solvent in which NaCl can be dissolved without dissolving lithium carbonate may be used, and preferably, water, alcohol, ammonia and the like may be used, and most preferably, water or methanol may be used. In this case, the solubility difference between lithium carbonate and NaCl is large, which may be advantageous in that high-purity lithium carbonate may be easily separated.

In addition, the amount of the solvent used may be appropriately selected in consideration of the amounts of lithium carbonate and NaCl included in the second mixture, and more preferably, 100 to 50,000 parts by weight of the solvent may be additionally introduced based on the total weight of the second mixture transferred to step (4).

In this case, the process of using the drying may be performed at a temperature of 20 to 200° C., and more preferably, at a temperature of 50 to 150° C. under a vacuum condition. This may be appropriately selected in consideration of the type and nature of the solvent included in the second mixture.

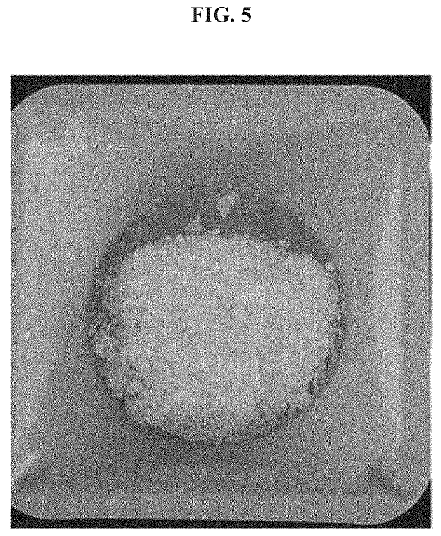

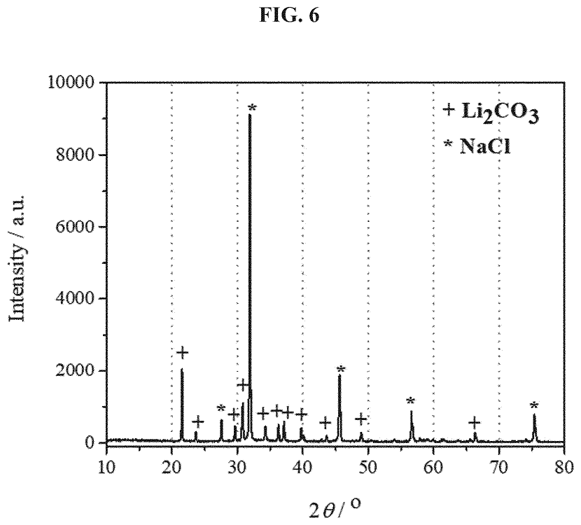

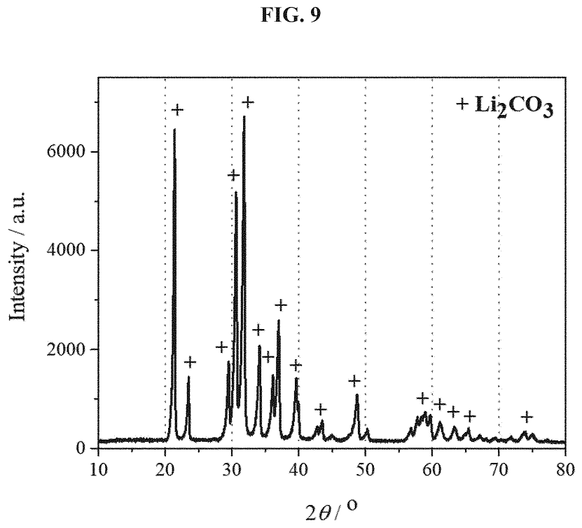

Meanwhile, FIG. 5 shows a state after evaporating all of the solvent by drying the solution including the chloride under vacuum conditions at 120° C. according to step (4-1) of the present invention. Referring to FIG. 5, it can be seen that both lithium carbonate and NaCl were separated into solid powders, and furthermore, through FIG. 6, which is the result of an X-ray diffraction experiment, no peaks other than lithium carbonate and NaCl were observed, and thus, it can be seen that it was separated into pure lithium carbonate and NaCl. Afterwards, lithium carbonate and NaCl may be separated using the difference in solubility after the second solvent is introduced in aforementioned step (4-2), and for example, through FIG. 9, which is the result of an X-diffraction experiment of lithium carbonate separated using methanol, it can be seen that it was separated into a pure lithium carbonate material in which no other substances were observed. The lithium carbonate separated according to the above process may be transferred to a synthesis process and recycled as a transition metal precursor.

As such, in the method for recycling a positive electrode material for secondary batteries according to the present invention, lithium carbonate and NaCl may be easily separated through step (4) to selectively obtain lithium, and at the same time, it is possible to implement an environmentally friendly separation process, and since an additional purification process or the like is not required, it is possible to simultaneously achieve process simplification and cost reduction.

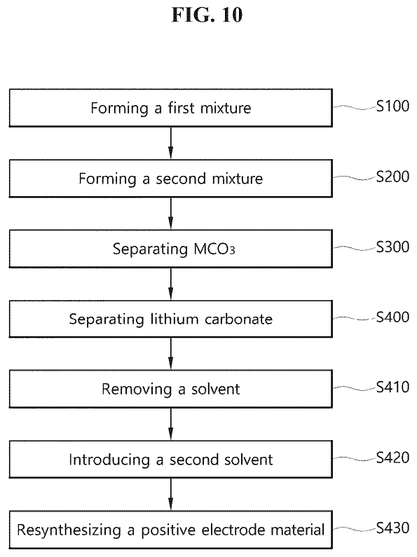

Next, as illustrated in FIG. 10, an exemplary embodiment of the method for recycling a positive electrode material for secondary batteries according to the present invention may further include a process of reproducing a positive electrode material for secondary batteries by resynthesizing the positive electrode material separated through the aforementioned steps as (4-3) step S430. That is, the positive electrode material for secondary batteries may be reproduced by resynthesizing MOₓ, MCO₃ and lithium carbonate, which are the positive electrode materials separated in the aforementioned steps, and, if necessary, additional lithium carbonate may be added to reproduce the desired amount of LMO₂.

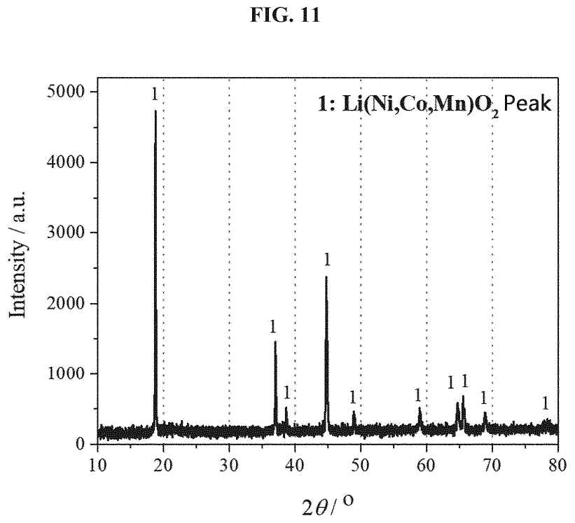

More specifically, it will be described with reference to FIGS. 10 and 11.

FIG. 11 is a diagram showing the results of X-ray diffraction analysis of a synthesized sample that was subjected to a resynthesis process through heat treatment after additionally adding and mixing a certain amount of lithium carbonate to MOₓ, MCO₃ and lithium carbonate separated in the aforementioned steps. Referring to FIG. 11, it can be seen that the same phase as the original Li(Ni, Co, Mn)O₂ phase was formed in the synthesized sample, and through this, it can be seen that the positive electrode material decomposed and separated from the waste battery was recycled.

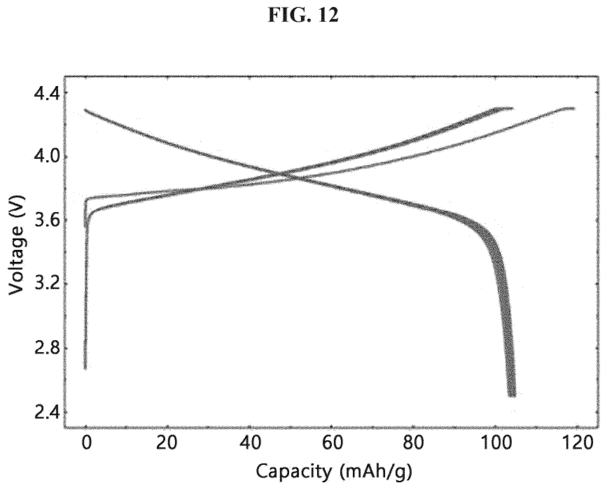

In addition, FIG. 12 shows a charge/discharge experiment after manufacturing a secondary battery using the resynthesized sample, and referring to this, in the case of a secondary battery manufactured using the resynthesized sample, it showed a value of 105 mAh/g, and this indicates about 90% capacity of the initial charging capacity of 120 mAh/g, and through this, the secondary battery manufactured using the resynthesized sample according to the present invention also stably performed charging and discharging operations and showed high recycling efficiency.

As described above, the method for recycling a positive electrode material for secondary batteries according to the present invention is implemented by including a step of chlorinating the positive electrode material including LMOₓ separated from the battery with a gas including chlorine to separate MOₓ, and in this case, L is lithium (Li), M is one or more selected from cobalt (Co), nickel (Ni), aluminum (Al) and manganese (Mn), and X is a constant of 0.5 to 2.5.

Through this, it is possible to safely separate the positive electrode materials included in the waste battery and efficiently recycle the same, thereby reducing social and economic costs due to the rapidly increasing use of secondary batteries. Moreover, in the process of separating the positive electrode materials included in the waste battery, it is possible to omit a purification process, which was additionally required due to the chemical properties of the positive electrode material, thereby simplifying the entire process and maximizing the efficiency of the separation process.

Furthermore, according to the method for recycling a positive electrode material for secondary batteries according to the present invention, no additional acid waste is generated because strong acid is not used in the process of separating the positive electrode materials included in the waste battery, and only Li may be selectively recovered such that in the separation process as well as in the resynthesis process, it is possible to significantly improve the treatment efficiency and economic feasibility.

Meanwhile, the present invention provides a device for recycling a positive electrode material for secondary batteries, which implements the above-described method for recycling a positive electrode material for secondary batteries and a positive electrode material for secondary batteries implemented through the same, and hereinafter, the device for recycling a positive electrode material for secondary batteries for implementing the method for recycling a positive electrode material for secondary batteries according to the present invention will be described. In order to avoid duplication, descriptions of the same parts as in the method for recycling a positive electrode material for secondary batteries will be omitted.

The present invention provides a device for recycling a positive electrode material for secondary batteries, including a first reaction unit for forming a first mixture by chlorinating a positive electrode material including LMOₓ separated from a battery with a gas including chlorine, a first separation unit for communicating with the first reaction unit and contacting the first mixture with a solvent to separate MOₓ and forming a second mixture including the solvent, a second separation unit for communicating with the first separation unit and separating MCO₃ by reacting the second mixture with carbonate, and a third separation unit for communicating with the second separation unit and separating lithium carbonate from the second mixture from which the MCO₃ is separated. In this case, L is lithium (Li), O is oxygen, M is one or more selected from cobalt (Co), nickel (Ni), aluminum (Al) and manganese (Mn), and X is a constant of 0.5 to 2.5.

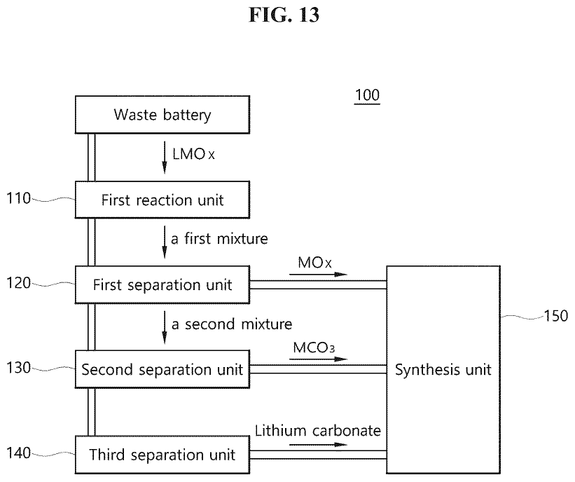

FIG. 13 is a diagram showing the device for recycling a positive electrode material for secondary batteries for implementing the method for recycling a positive electrode material for secondary batteries according to the present invention, and hereinafter, it will be described with reference to FIG. 13.

In the first reaction unit 110, a chlorination reaction is performed to separate MOₓ and chloride.

More specifically, in the first reaction unit 110, the positive electrode material including LMOₓ separated from a battery may be subjected to a chlorination reaction with a gas including chlorine to obtain a first mixture including MOₓ and chloride. That is, lithium of LMOₓ may be obtained by converting into LiCl, and M, which is a positive electrode material, may be separated into an oxide in the form of MOₓ or MCl_{y}.

Accordingly, the first reaction unit 110 may further include a separate gas injection unit (not illustrated) for injecting the gas including chlorine. In addition, the chlorination reaction in the first reaction unit 110 may further include a heater (not illustrated) for maintaining a high temperature condition because LMOₓ reacts with the gas under a high temperature condition. The shape and material of the injection unit and the heater are not particularly limited as they may be conventional as long as they meet the purpose of the present invention.

Next, the first separation unit 120 communicates with the first reaction unit 110 and contacts the first mixture with a solvent to separate MOₓ and form a second mixture including the solvent.

More specifically, the first mixture formed in the first reaction unit 110 may be transferred to the first separation unit 120 through a transfer path (not illustrated), and the transferred first mixture comes into contact with a solvent such that chlorides such as LiCl or the like are dissolved in the solvent and converted into a liquid phase, and MOₓ that has not reacted with chlorine remains in a solid state and may be easily separated as it is washed through the solvent.

Accordingly, the first separation unit 120 may further include a solvent injection unit (not illustrated) for injecting a solvent, and the shape and material of the injection unit are not particularly limited as long as they meet the purpose of the present invention.

Next, the second separation unit 130 communicates with the first separation unit 120 and reacts the second mixture with carbonate to separate MCO₃.

More specifically, the second mixture including chloride such as LiCl or the like dissolved in a solvent in the first separation unit 120 and present in a liquid phase is transferred to the second separation unit 130 through a transfer path (not illustrated), and the transferred second mixture may be reacted with carbonate and separated into lithium carbonate (Li₂CO₃) including lithium and MCO₃ including a positive electrode metal material as products.

Accordingly, the second separation unit 130 may be provided with carbonate in advance for reacting with the second mixture transferred from the first separation unit 120, but is not limited thereto, and carbonate may be injected through an additional injection unit (not illustrated).

Next, the third separation unit 140 communicates with the second separation unit 130 and separates lithium carbonate from the second mixture from which MCO₃ is separated.

More specifically, lithium may be selectively recovered by separating lithium carbonate and NaCl dissolved in the solvent as the second mixture in the third separation unit 140, and in particular, by drying the second mixture including the solvent to remove all or part of the solvent included therein, lithium carbonate and NaCl present in a solution state in the second mixture may be separated by a difference in solubility with respect to the solvent.

Accordingly, the third separation unit 140 may also further include a solvent injection unit (not illustrated) for injecting a solvent, and the shape and material of the injection unit are not particularly limited as long as they meet the purpose of the present invention.

Next, the device for recycling a positive electrode material for secondary batteries according to the present invention communicates with the first separation unit 120, the second separation unit 130 and the third separation unit 140, and may further include a synthesis unit for reproducing LMOₓ from MOₓ, MCO₃ and lithium carbonate which are separated in the first separation unit 120, the second separation unit 130 and the third separation unit 140.

That is, it is possible to reproduce the positive electrode material for secondary batteries through a conventional resynthesis process of MOₓ, MCO and lithium carbonate which are positive electrode materials separated from each of the above-described separation units. and, if necessary, additional lithium carbonate may be added to reproduce the desired amount of LMO₂.

Hereinafter, the present invention will be described in more detail through examples, but the following examples are not intended to limit the scope of the present invention, but these should be construed to help the understanding of the present invention.

### Example

### (1) Chlorination Step and (2) MOₓ Separation Step

1.0 g of positive electrode material Li(Ni, Co, Mn)O₂ including nickel, cobalt, and manganese at a 1:1:1 ratio separated from a waste secondary battery was prepared as a sample.

Next, the weight change of the reaction product was measured by respectively changing the temperature and time of 1.0 g of the prepared sample under the conditions of argon gas at 95 mL/min and chlorine gas at 5 mL/min as shown in Table 1 below.

TABLE 1

| | 500° C. | 550° C. | 600° C. |
|---|---|---|---|
| 1 hour | +17.6% | +19.8% | +21.2% |
| 2 hours | +19.9% | +23.8% | +30.0% |
| 4 hours | +20.7% | +28.9% | +37.2% |
| 6 hours | +22.1% | +31.4% | +40.0% |

Referring to Table 1, it can be seen that as the reaction proceeded, the weight increased because the site of oxygen having an atomic weight of 16 was replaced by chlorine having an atomic weight of 35, which confirms that the generated chloride was not volatilized. The phenomenon that the weight increase rate decreases as the reaction time increases at each temperature indicates that lithium was rapidly converted into chloride at the beginning and the chlorination reaction of the transition metal proceeded slowly thereafter.

Through this, it can be seen that the selective separation of lithium is possible according to the method for recycling a positive electrode material for secondary batteries according to the present invention.

In addition, the result of an X-ray diffraction experiment in which 1.0 g of the sample prepared in the Examples was reacted for 6 hours at 500° C. under the conditions of argon gas at 95 mL/min and chlorine gas at 5 mL/min is shown in FIG. 3B, and the result of the X-ray diffraction after washing the same is illustrated in FIG. 3C. In addition, the result of an X-ray diffraction experiment reacted at 550° C. for 4 hours is shown in FIG. 3D, and the result of the X-ray diffraction experiment after washing the same is shown in FIG. 3E. In addition, the result of an X-ray diffraction experiment reacted at 600° C. for 2 hours is shown in FIG. 3F, and the result of the X-ray diffraction experiment after washing the same is shown in FIG. 3G, and the result of the X-ray diffraction experiment of the sample before reacting under the above gas condition is shown in FIG. 3A. 250 ml of water was used for washing.

Referring to FIGS. 3A to 3G, from the analysis results of the X-ray diffraction experiments, it was confirmed that in the case of the samples reacted at 550° C. and 600° C., it was confirmed that these were converted to the form of M₃O₄ after washing, but in the case of the sample reacted at 500° C., it was confirmed that the phase of the initial sample was maintained. Through this, it was confirmed that Li was converted to LiCl through the chlorination reaction under the optimum conditions of 550° C. and 600° C., and selective separation was thereby possible.

In addition, the result of an X-ray diffraction experiment in which the amount of the positive electrode material was increased to 2.0 g and it was reacted at 550° C. for 4 hours under the conditions of argon gas at 180 mL/min and chlorine gas at 20 mL/min is shown in FIG. 3H, and the result of the X-ray diffraction experiment after washing the same is shown in FIG. 3I. Also in this case, it was confirmed that the chlorination reaction was possible under various conditions by confirming the conversion to the form of M₃O₄.

Through this, it can be seen that, according to the method for recycling a positive electrode material for secondary batteries according to the present invention, not only the selective separation of lithium, but also the selective separation of the positive electrode metal material is possible.

### (3) Separating Step of MCO₃

250 ml of water was mixed with 2 g of the sample in which the chlorination reaction was performed in steps (1) and (2) above to charge Na₂CO₃ (1.43 g) into the aqueous solution from which MOₓ was separated to perform the MCO₃ precipitation experiment, and the results are shown in FIG. 4. Referring to FIG. 4, it can be seen that a brown MCO₃ precipitate was formed, and through this, it can be seen that the selective separation of the positive electrode material metal material is possible according to the method for recycling a positive electrode material for secondary batteries according to the present invention.

(4) Separating Step of Li₂CO₃

Next, 250 ml of the Li₂CO₃/NaCl/H₂O solution from which the MCO₃ precipitate was separated in step (3) above was sufficiently dried under a vacuum condition at 120° C. to separate Li₂CO₃/NaCl from which all of the water was evaporated, and the result is shown in FIG. 5.

Afterwards, an X-ray diffraction experiment of the separated Li₂CO₃/NaCl was performed, and the result is shown in FIG. 6.

Referring to FIGS. 5 and 6, it can be seen that Li₂CO₃ and NaCl were separated from the Li₂CO₃/NaCl/H₂O solution, and through the result that other phases besides Li₂CO₃ and NaCl were not formed, it can be seen that, according to the method for recycling a positive electrode material for secondary batteries according to the present invention, not only the selective separation of lithium, but also the independent and selective separation of different positive electrode metal materials is possible.

(4-1) And (4-2) Separating Steps of Li₂CO₃

The separation process was performed by adding 3.38 g of water according to the solubility of NaCl to 1.99 g of Li₂CO₃/NaCl from which all of the water was evaporated in step (4) above, and the result is shown in FIG. 7.

Afterwards, an X-ray diffraction experiment of the separated Li₂CO₃ was performed, and the result is shown in FIG. 8.

Another separation process was performed by adding 150 g of methanol to 1.99 g of Li₂CO₃/NaCl from which all of the same water was evaporated in step (4) above. Afterwards, an X-ray diffraction experiment of the separated Li₂CO₃ was performed, and the result is shown in FIG. 9.

Referring to FIGS. 8 and 9, according to the method for recycling a positive electrode material for secondary batteries according to the present invention through the result of the separation of high-purity Li₂CO₃ from the Li₂CO₃/NaCl/H₂O solution, it can be seen that not only the selective separation of lithium, but also the independent and selective separation of different positive electrode metal materials is possible.

### (4-3) Resynthesizing Step

*163 Li₂CO₃ (0.211 g) was additionally added and mixed with MOₓ (1.388 g) separated without reacting with chlorine in Experimental Example 1 above, MCO₃ (0.273 g) separated in Experimental Example 3, and Li₂CO₃ (0.708 g) separated in Experimental Examples 5 and 6, followed by heat treatment at 900° C. for 3 hours in air to resynthesize LMO₂.

Afterwards, an X-ray diffraction experiment of the resynthesized LMO₂ was performed, and the result is shown in FIG. 11. Referring to FIG. 11, it can be seen that the same phase as the initial LMO₂ phase was formed.

Through this, according to the method for recycling a positive electrode material for secondary batteries according to the present invention, it can be seen that the positive electrode material for secondary batteries may be efficiently recycled through a simple process.

### Experimental Example—Charging/Discharging Experiment of the Resynthesized Sample

A battery was manufactured using the resynthesized LMO₂, and a charge/discharge experiment was performed. In order to manufacture electrodes for evaluating the electrochemical properties, after preparing a slurry in which LMO₂ resynthesized in an n-methyl-2-pyrrolidone (NMP) solvent, a polyvinylidene fluoride (PVDF) binder, and conductive carbon were mixed at a mass ratio of 8:1:1, respectively, the slurry was coated on aluminum foil and dried in a vacuum oven to remove NMP to complete the manufacture of electrodes.

A CR2032 coin cell was manufactured by using the electrode as a positive electrode, a lithium metal as a negative electrode, 1 M LiPF₆ in EC/DMC (ethylene carbonate/dimethyl carbonate) as an electrolyte, and a glass fiber membrane as a separation membrane. The manufactured coin cell was processed by using a battery cycler in the constant current-constant voltage (CCCV) mode, under the condition of a constant current of 20 mA/g in a voltage range of 2.5 to 4.3 V, and in order to sufficiently secure the charging capacity, when the voltage reached 4.3 V during charging, the 4.3 V constant voltage was additionally maintained for 20 minutes, and the result is shown in FIG. 12.

Referring to FIG. 12, it can be seen that the initial charging capacity was confirmed to be about 120 mAh/g, and then the charging/discharging operation was stably performed at a level of about 105 mAh/g.

Through this, it was confirmed that the NCM positive electrode material may be recycled through the process presented in the present invention, and the final synthesized amount was confirmed to be 90% of the amount used in the first reaction, and thus, it can be confirmed that the process presented in the present invention is simple and has high efficiency.

The invention claimed is:

1. A method for recycling a positive electrode material for secondary batteries, comprising:
(1) forming a first mixture by chlorinating a positive electrode material including LMOₓ separated from a battery with a gas including chlorine (S100);
(2) contacting the first mixture with a solvent to separate MOₓ and forming a second mixture including the solvent (S200);
(3) separating MCO₃ by reacting the second mixture with carbonate (S300); and
(4) separating lithium carbonate (Li₂CO₃) from the second mixture from which MCO₃ is separated (S400),
wherein L is lithium (Li), M is one or more selected from cobalt (Co), nickel (Ni), aluminum (Al) and manganese (Mn), and X is a constant of 0.5 to 2.5.

2. The method of claim 1, wherein the temperature for chlorinating is 450 to 700° C.

3. The method of claim 1, wherein the gas including chlorine is chlorine gas (Cl₂).

4. The method of claim 1, wherein the first mixture in step (1) comprises LiCl, MCl_{y} and MOₓ, and
wherein y is a constant of 1 to 3.

5. The method of claim 3, wherein the chlorine gas is included at 5 to 90 wt % based on the total weight of the gas including chlorine.

6. The method of claim 1, wherein the solvent in step (2) is any one or more of water or alcohol.

7. The method of claim 1, wherein the carbonate in step (3) is any one of sodium carbonate or potassium carbonate.

8. The method of claim 1, wherein step (4) is drying the second mixture from which MCO₃ is separated to remove a part of the solvent to separate lithium carbonate by a difference in solubility with respect to the solvent.

9. The method of claim 1, wherein step (4) further comprises:
(4-1) drying the second mixture from which MCO₃ is separated to remove all or part of the solvent (S410); and
(4-2) additionally introducing a second solvent to separate lithium carbonate and sodium chloride included in the second mixture by using a difference in solubility with respect to the solvent (S420).

10. The method of claim 1, further comprising:
(4-3) reproducing LMOₓ by using the separated MOₓ, MCO₃ and lithium carbonate (S430).

11. A positive electrode material for secondary batteries, which is reproduced by the method according to claim 1.

12. A method for recycling a positive electrode material for secondary batteries, comprising:
separating MOₓ by chlorinating a positive electrode material including LMOₓ separated from a battery with a gas including chlorine,
wherein L is lithium (Li), M is one or more selected from cobalt (Co), nickel (Ni), aluminum (Al) and manganese (Mn), and X is a constant of 0.5 to 2.5.

13. A device for recycling a positive electrode material for secondary batteries, comprising:
a first reaction unit for forming a first mixture by chlorinating a positive electrode material including LMOₓ separated from a battery with a gas including chlorine;
a first separation unit for communicating with the first reaction unit and contacting the first mixture with a solvent to separate MOₓ and forming a second mixture including the solvent;
a second separation unit for communicating with the first separation unit and separating MCO₃ by reacting the second mixture with carbonate; and
a third separation unit for communicating with the second separation unit and separating lithium carbonate from the second mixture from which the MCO₃ is separated, wherein L is lithium (Li), O is oxygen, M is one or more selected from cobalt (Co), nickel (Ni), aluminum (Al) and manganese (Mn), and X is a constant of 0.5 to 2.5.

14. The device of claim 13, further comprising a synthesis unit for communicating with the first separation unit, the second separation unit and the third separation unit and reproducing LMOₓ from MOₓ, MCO₃ and lithium carbonate separated in the first separation unit, the second separation unit and the third separation unit.

15. The device of claim 13, wherein the first reaction unit further comprises a gas injection unit for injecting gas into the first reaction unit.

16. The device of claim 13, wherein the first reaction unit further comprises a heater for maintaining a gas including chlorine at a high temperature.

17. The device of claim 13, wherein the first separation unit further comprises a solvent injection unit for injecting a solvent.
